(19) United States
(12) Patent Application Publication
(10) Pub. No.: US 2016/0168348 A1
(43) Pub. Date: Jun. 16, 2016

(54) POLYURETHANE FOAM COMPOSITION FOR DISCONTINUOUS PANELS FORMED UNDER A REDUCED PRESSURE

(71) Applicant: DOW GLOBAL TECHNOLOGIES LLC, Midland, MI (US)

(72) Inventors: Paolo Golini, Correggio (IT); Cecilia Girotti, Correggio (IT); Giuseppe Vairo, Correggio (IT)

(73) Assignee: Dow Global Technologies LLC, Midland, MI (US)

(21) Appl. No.: 14/905,483

(22) PCT Filed: Jul. 18, 2014
(86) PCT No.: PCT/IT2014/000192

§ 371 Date: Jan. 15, 2016

(30) Foreign Application Priority Data
Jul. 18, 2013 (IT) M12013A001210

(51) Int. Cl. C08J 9/14; C08J 9/00

(52) U.S. Cl. CPC C08J 9/141; C08J 9/0061; C08J 2375/08

(57) ABSTRACT

Embodiments of the present disclosure provide for a composition for forming a polyurethane foam and a method of forming the polyurethane foam using the composition. The polyurethane foam includes a formulated polyol, an isocyanate and a blowing agent. The formulated polyol includes 60 weight percent (wt. %) to 80 wt. % of a polyether polyol and 10 wt. % to 25 wt. % of an aromatic polyester polyol, where the wt. % are based on a total weight of the formulated polyol, and where the formulated polyol has a polyol mixture functionality of 3.8 to 5.5.

The present disclosure relates generally to compositions for polyurethane foams and more particularly to compositions for polyurethane foams formed under a reduced pressure.

Polyurethane foams are widely used as insulating materials. The insulating properties of polyurethane foam come from their closed-cell structure, where each closed-cell contains a low-conductivity gas such as a hydrocarbon (HC).

Polyurethane foams are formed from liquid compositions that foam and cure, where the liquid composition can be poured and/or sprayed to form the desired shape. A cycle time is the total time, from beginning to end, to produce the polyurethane foam in its desired shape. Reducing the cycle time is one of the most relevant factors in improving the economic efficiencies in the use and application of polyurethane foams. The cycle time of producing polyurethane foam depends greatly on how quickly the polyurethane foam cures under a given condition. If the polyurethane foam is released from its mold too quickly, in an effort to improve cycle time, the result can be defects in the foam such as shrinkage and deformation.

As such, there is a need in the art for polyurethane foams that exhibit improvements in cycle times for the production of polyurethane foam.

The present disclosure provides a composition for forming a polyurethane foam and a method of forming polyurethane foam under a reduced pressure, which helps to improve the cycle time for the production of the polyurethane foam. The composition includes a formulated polyol, an isocyanate and a blowing agent. The formulated polyol includes 60 weight percent (wt. %) to 80 wt. % of a polyether polyol and 10 wt. % to 25 wt. % of an aromatic polyester polyol, where the wt. % are based on a total weight of the formulated polyol, and where the formulated polyol has a polyol mixture functionality of 3.8 to 5.5. The polyol mixture functionality is a weighted accounting of hydroxyl (—OH) groups per molecule contributed by each polyol to the formulated polyol (the sum of the —OH groups per molecule of each specific polyol multiplied by weight percentage of the specific polyol for the formulated polyol).

The present disclosure also provides for a polyurethane foam produced from the composition. The present disclosure further provides for a method of forming the polyurethane foam that includes injecting the composition for forming the polyurethane foam under foam-forming conditions into a mold at a reduced pressure of at least 5000 pascal (Pa) below standard pressure of 100 kilopascal (kPa), curing the composition for forming the polyurethane foam in the mold, and demolding the polyurethane foam from the mold.

Each polyether polyol used in the composition for forming the polyurethane foam has a polyol functionality of greater than or equal to four (4). The polyether polyol is selected from the group consisting of a sucrose/glycerine-initiated polyether polyol, a sorbitol propoxylated polyol or a combination thereof. The polyether polyol can have a hydroxyl number of 100 mg KOH/g to 800 mg KOH/g.

The aromatic polyester polyol can have a polyol functionality of greater than or equal to 2. The aromatic polyester polyol can be selected from the group consisting of a diethylene glycol-phthalic anhydride based polyester polyol, a diethylene glycol-phthalic anhydride/glycerin based polyester polyol or a combination thereof. The aromatic polyester polyol has an aromatic ring content of 70 to 90 percent by weight based on a total weight of the aromatic polyester polyol. The aromatic polyester polyol has a hydroxyl number of 150 mg KOH/g to 350 mg KOH/g.

The isocyanate can have a functionality from 2.5 to 3. The isocyanate can be a polymeric methylene diphenyl diisocyanate. The blowing agent is selected from the group consisting of a hydrocarbon, a hydrofluoro-olefin (HFO), a hydrochlorofluoro-olefin (HCFO), a hydrofluorocarbon or a combination thereof.

The present disclosure offers both process and property improvements that are advantageous in the polyurethane industry. The present disclosure provides a composition for forming a polyurethane foam that helps to improve the cycle time for the production of the polyurethane foam. The composition includes a formulated polyol, an isocyanate and a blowing agent. The formulated polyol includes 60 weight percent (wt. %) to 80 wt. % of a polyether polyol and 10 wt. % to 25 wt. % of an aromatic polyester polyol, where the wt. % are based on a total weight of the formulated polyol, and where the formulated polyol has a polyol mixture functionality of 3.8 to 5.5.

### Formulated Polyol

Polyols useful in the present disclosure are compounds which contain two or more isocyanate reactive groups, generally active-hydrogen groups, such as —OH, primary or secondary amines, and —SH. As discussed herein, the formulated polyol includes the polyether polyol and the aromatic polyester polyol. The formulated polyol includes 60 wt. % to 80 wt. % of the polyether polyol and 10 wt. % to 25 wt. % of the aromatic polyester polyol, where the wt. % are based on a total weight of the formulated polyol. Combinations of more than one of each type of polyol (e.g., polyether polyol and aromatic polyester polyol) may also be selected, provided their combined percentages in the formulated polyol as a whole comply with the stated ranges.

The formulated polyol has a polyol mixture functionality of 3.8 to 5.5. As used herein, a polyol mixture functionality is a weighted accounting of hydroxyl (—OH) groups per molecule contributed by each polyol (e.g., each polyether polyol and each aromatic polyester polyol) to the formulated polyol. So, in order to determine the polyol mixture functionality the sum of the —OH groups per molecule of each polyol is multiplied by a weight percentage of each polyol in the formulated polyol.

For example, Voranol RN-482 is sorbitol initiated polyol. Sorbitol has 6 —OH groups per molecule. In the case where 40 wt % of Voranol RN-482 is used in the formulated polyol, based on the total weight of the formulated polyol, the functionality contribution provided by the Voranol RN482 in that specific amount is 6×0.4=2.4. This calculation is also determined for the other polyols in the formulated polyol, where the sum of all functionality values is the polyol mixture functionality.

### Formulated Polyol—Polyether Polyol

The formulated polyol includes 60 wt. % to 80 wt. % of a polyether polyol, where the wt. % are based on a total weight of the formulated polyol. The polyether polyol can have a hydroxyl number of 100 mg KOH/g to 800 mg KOH/g. In an additional embodiment, the polyether polyol can have a hydroxyl number of 100 mg KOH/g to 600 mg KOH/g. In a further embodiment, the polyether polyol can have a hydroxyl number of 300 mg KOH/g to 600 mg KOH/g. The hydroxyl number gives the hydroxyl content of a polyol, and is derived from method of analysis by acetylating the hydroxyl and titrating the resultant acid against KOH. The hydroxyl number is the weight of KOH in milligrams that will neutralize the acid from 1 gram of polyol. The equivalent weight of KOH is 56.1, hence:

Hydroxyl Number=(56.1×1000)/Equivalent Weight

where 1000 is the number of milligrams in one gram of sample.

Each polyether polyol used in the composition for forming the polyurethane foam also has a functionality [e.g., —OH groups per molecule of polyether polyol] of greater than or equal to 4. In an additional embodiment, the polyether polyol can have a functionality of 4 to 6.0. More specifically, the polyether polyol can have a functionality of 4.5 to 6.0, which may be particularly desirable in some embodiments. As used herein, the polyol functionality is not an average value, but a discrete value for each polyether polyol.

The polyether polyols include those obtained by the alkoxylation of suitable starting molecules with an alkylene oxide, such as ethylene, propylene, butylene oxide, or a combination thereof. Examples of initiator molecules include toluene diamine pentaerythritol, xylitol, arabitol, sorbitol, sucrose, mannitol and the like.

As provided herein, the polyether polyol can be a sucrose-initiated or a sorbitol-initiated polyether polyol. For example, the polyether polyol can be selected from the group consisting of a sucrose/glycerine-initiated polyether polyol, a sorbitol propoxylated polyol or a combination thereof. Sucrose may be obtained from sugar cane or sugar beets, honey, sorghum, sugar maple, fruit, and the like. Means of extraction, separation, and preparation of the sucrose component vary depending upon the source, but are known and practiced on a commercial scale by those skilled in the art. Sorbitol may be obtained via the hydrogenation of D-glucose over a suitable hydrogenation catalyst. Fixed beds and similar types of equipment are especially useful for this reaction. Suitable catalysts may include, for example, Raney™ (Grace-Davison) catalysts, such as employed in Wen, Jian-Ping, et. al., “Preparation of sorbitol from D-glucose hydrogenation in gas-liquid-solid three-phase flow airlift loop reactor,” The Journal of Chemical Technology and Biotechnology, vol. 4, pp. 403-406 (Wiley Interscience, 2004), incorporated herein by reference in its entirety. Nickel-aluminum and ruthenium-carbon catalysts are just two of the many possible catalysts.

In an alternative embodiment, preparation of sorbitol may begin with a starch hydrolysate which has been hydrogenated. The starch is a natural material derived from corn, wheat and other starch-producing plants. To form the hydrolysate, the starch polymer molecule may be broken into smaller oligomers at the ether bond between glucose rings, to produce glucose, maltose and higher molecular weight oligo- and polysaccharides. The resulting molecules, having hemiacetal glucose rings as end units, may then be hydrogenated to form sorbitol, maltitol and hydrogenated oligo- and polysaccharides. Hydrogenated starch hydrolysates are commercially available and inexpensive, often in the form of syrups, and provide the added benefit of being a renewable resource. This method may further require a separation of either the glucose, prior to hydrogenation, or of the sorbitol after hydrogenation, in order to prepare a suitable sorbitol-initiated polyol therefrom. In general, the hydrogenation reduces or eliminates the end units' tendency to form the hydroxyaldehyde form of glucose. Therefore, fewer side reactions of the sorbitol, such as Aldol condensation and Cannizzaro reactions, may be encountered. Furthermore, the final polyol will comprise reduced amounts of by-products.

The sucrose-initiated or sorbitol-initiated polyol may be made by polymerizing alkylene oxides onto the specified initiator in the presence of a suitable catalyst. In one embodiment, each of the initiators may be individually alkoxylated in separate reactions and the resulting polyols blended to achieve the desired component of the polyether polyol for use in the formulated polyol. In another embodiment, the initiators may be mixed together prior to alkoxylation, thereby serving as co-initiators, prior to preparing the polyether polyol component having a target hydroxyl number and functionality.

To accomplish the alkoxylation, the alkylene oxide or mixture of alkylene oxides may be added to the initiator(s) in any order, and can be added in any number of increments or added continuously. Adding more than one alkylene oxide to the reactor at a time results in a block having a random distribution of the alkylene oxide molecules, a so-called heteric block. To make a block polyoxy-alkylene of a selected alkylene oxide, a first charge of alkylene oxide is added to an initiator molecule in a reaction vessel. After the first charge, a second charge can be added and the reaction can go to completion. Where the first charge and the second charge have different relative compositions of alkylene oxides, the result is a block polyoxyalkylene. It is preferred to make block polyols in this fashion where the blocks thus formed are either all ethylene oxide, or all propylene oxide, or all butylene oxide, but intermediate compositions are also possible. The blocks can be added in any order, and there may be any number of blocks. For example, it is possible to add a first block of ethylene oxide, followed by a second block of propylene oxide. Alternatively, a first block of propylene oxide may be added, followed by a block of ethylene oxide. Third and subsequent blocks may also be added. The composition of all the blocks is to be chosen so as to give the final material the properties required for its intended application.

### Formulated Polyol—Aromatic Polyester Polyol

The formulated polyol also includes 10 wt. % to 25 wt. % of an aromatic polyester polyol, where the wt. % are based on a total weight of the formulated polyol. As used herein, “aromatic” refers to organic compounds having at least one conjugated ring of alternate single and double bonds. The term “polyester polyol” as used herein can include minor amounts of unreacted polyol remaining after the preparation of the polyester polyol and/or unesterified polyol (for example, glycol) added after the preparation of the polyester polyol. While the aromatic polyester polyol may be prepared from substantially pure reactant materials, more complex starting materials, such as polyethylene terephthalate, may be advantageous. Other residues are dimethyl terephthalate (DMT) process residues, which are waste or scrap residues from the manufacture of DMT.

The aromatic polyester polyol may optionally contain, for example, halogen atoms and/or may be unsaturated, and may generally be prepared from the same selection of starting materials as described herein, but at least one of the polyol or the polycarboxylic acid, preferably the acid, is an aromatic compound having an aromatic ring content (expressed as weight percent of groups containing at least one aromatic ring per molecule) that is at least about 50 percent by weight, based on the total compound weight, and preferably greater than about 50 percent by weight, i.e., it is predominantly aromatic in nature. Polyester polyols having an acid component that advantageously comprises at least about 30 percent by weight of phthalic acid residues, or residues of isomers thereof, are particularly useful. Preferably the aromatic ring content of the aromatic polyester polyol is from 70 to 90 percent by weight, based on a total weight of the aromatic polyester polyol. Preferred aromatic polyester polyols are the crude polyester polyols obtained by the transesterification of crude reaction residues or scrap polyester resins.

The aromatic polyester polyol is also characterized in that it has a hydroxyl number of 150 mg KOH/g and greater. For example, the aromatic polyester polyol can have a hydroxyl number from 150 mg KOH/g to 350 KOH/g. In preferred embodiments, the hydroxyl number ranges from 150 KOH/g to 300 mg KOH/g. The aromatic polyester polyol can have a polyol functionality of greater than or equal to 2. Preferably, the polyol functionality of the aromatic polyester polyol can be from 2 to 8, but in certain non-limiting embodiments may range from 2 to 6.

The aromatic polyester polyol can be selected from the group consisting of a diethylene glycol-phthalic anhydride based polyester polyol, a diethylene glycol-phthalic anhydride/glycerin based polyester polyol or a combination thereof. Examples of other useful aromatic polyester polyols for the present disclosure include, but are not limited to, those ortho acid polyester polyols, terephtalic acid polyester polyols, anhydride polyester polyols, polyester polyols or a combination thereof. Examples of the aromatic polyester polyols can be prepared from organic dicarboxylic acids having from 2 to 12 carbon atoms, preferably aromatic dicarboxylic acids having from 8 to 12 carbon atoms, and polyhydric alcohols, preferably diols, having from 2 to 12, preferably from 2 to 8 and more preferably 2 to 6 carbon atoms. Preferred aromatic dicarboxylic acids are phthalic acid, isophthalic acid, terephthalic acid and isomers of naphthalene-dicarboxylic acids. Such acids may be used individually or as mixtures. Examples of dihydric and polyhydric alcohols include ethanediol, diethylene glycol, triethylene glycol, 1,2- and 1,3-propanediol, dipropylene glycol, 1,4-butanediol and other butanediols, 1,5-pentanediol and other pentanediols, 1,6-hexanediol, 1,10-decanediol, glycerol, and trimethylolpropane. Illustrative of the polyester polyols are poly(hexanediol adipate), poly(butylene glycol adipate), poly(ethylene glycol adipate), poly(diethylene glycol adipate), poly(hexanediol oxalate), poly(ethylene glycol sebecate), and the like.

While the aromatic polyester polyols can be prepared from substantially pure reactants materials, more complex ingredients can be used, such as the side-stream, waste or scrap residues from the manufacture of phthalic acid, terephtalic acid, dimethyl terephthalate, polyethylene terephthalate and the like. Other source is the recycled PET (polyethylene terephthalate). After transesterification or esterification the reaction products can optionally be reacted with an alkylene oxide.

### Isocyanate

The composition of the present disclosure also includes an isocyanate. In order to prepare the polyurethane foam, the formulated polyol reacts with the isocyanate and a blowing agent under appropriate foam-forming conditions. The isocyanate component is referred to in the United States as the “A-component” (in Europe, as the “B-component”). Selection of the A-component may be made from a wide variety of isocyanates, including but not limited to those that are well known to those skilled in the art. For example, polyisocyanates, organic polyisocyanates, modified polyisocyanates, isocyanate-based prepolymers, or a combination thereof may be employed. These may further include aliphatic and cycloaliphatic isocyanates, and in particular aromatic and, more particularly, multifunctional aromatic isocyanates. Also particularly preferred are polyphenyl polymethylene polyisocyanates (PMDI). For example, isocyanate can be a polymeric methylene diphenyl diisocyanate. The monomeric form of MDI is typically 30 percent to 70 percent diphenylmethane diisocyanate, and the balance is higher molecular-weight fractions.

Other isocyanates useful in the present disclosure include 2,4- and 2,6-toluenediisocyanate and the corresponding isomeric mixtures; 4,4′-, 2,4′- and 2,2′-diphenyl-methanediisocyanate and the corresponding isomeric mixtures; mixtures of 4,4′-, 2,4′- and 2,2′-diphenyl-methanediisocyanates and polyphenyl polymethylene polyisocyanates (PMDI); and mixtures of PMDI and toluene diisocyanates. Also useful herein are aliphatic and cycloaliphatic isocyanate compounds, such as 1,6-hexamethylenediisocyanate; 1-isocyanato-3,5,5-trimethyl-1,3-isocyaantomethylcyclo-hexane; 2,4- and 2,6-hexahydrotoluene-diisocyanate and their corresponding isomeric mixtures; and 4,4′-, 2,2′- and 2,4′-dicyclohexyl-methanediisocyanate and their corresponding isomeric mixtures. Also useful in the present disclosure is 1,3-tetra-methylene xylene diisocyanate.

Also advantageously used for the A-component are the so-called modified multifunctional isocyanates, that is, products which are obtained through chemical reactions of the above diisocyanates and/or polyisocyanates. Exemplary are polyisocyanates containing esters, ureas, biurets, allophanates and, preferably, carbodiimides and/or uretonimine, and isocyanurate and/or urethane group-containing diisocyanates or polyisocyanates. Liquid polyisocyanates containing carbodiimide groups, uretonimine groups and/or isocyanurate rings, having isocyanate groups (NCO) contents of from 120 to 40 weight percent, more preferably from 20 to 35 weight percent, can also be used. These include, for example, polyisocyanates based on 4,4′- 2,4′- and/or 2,2′-diphenylmethane diisocyanate and the corresponding isomeric mixtures, 2,4- and/or 2,6-toluenediisocyanate and the corresponding isomeric mixtures; mixtures of diphenylmethane diisocyanates and PMDI; and mixtures of toluenediisocyanates and PMDI and/or diphenylmethane diisocyanates.

Suitable prepolymers for use as the isocyanate component of the formulations of the present disclosure are prepolymers having a functionality [—N═C═O] content of from 2 to 40 weight percent, more preferably from 4 to 30 weight percent. These prepolymers are prepared by reaction of the di- and/or poly-isocyanates with materials including lower molecular weight diols and triols, but also can be prepared with multivalent active hydrogen compounds such as di- and tri-amines and di- and tri-thiols. Individual examples include aromatic polyisocyanates containing urethane groups, preferably having a functionality [—N═C═O] content of from 5 to 40 weight percent, more preferably 20 to 35 weight percent, obtained by reaction of diisocyanates and/or polyisocyanates with, for example, polyols such as lower molecular weight diols, triols, oxyalkylene glycols, dioxyalkylene glycols, or polyoxyalkylene glycols having molecular weights up to about 800. These polyols can be employed individually or in mixtures as di- and/or polyoxyalkylene glycols. For example, diethylene glycols, dipropylene glycols, polyoxyethylene glycols, ethylene glycols, propylene glycols, butylene glycols, polyoxypropylene glycols and polyoxypropylene polyoxyethylene glycols can be used. Polyester polyols can also be used, as well as alkyl diols such as butane diol. Other diols also useful include bishydroxyethyl- or bishydroxypropyl-bisphenol A, cyclohexane dimethanol, and bishydroxyethyl hydroquinone.

Useful polyisocyanate components of prepolymer formulations that may be employed in the present disclosure are: (i) polyisocyanates having an —N═C═O content of from 8 to 40 weight percent containing carbodiimide groups and/or urethane groups, from 4,4′-diphenylmethane diisocyanate or a mixture of 4,4′- and 2,4′-diphenylmethane diisocyanates; (ii) prepolymers containing NCO groups, having an —N═C═O content of from 2 to 35 weight percent, based on the weight of the prepolymer, prepared by the reaction of polyols having a functionality of preferably from 1.75 to 4 and a molecular weight of from 800 to 15,000 with either 4,4′-diphenylmethane diisocyanate, a mixture of 4,4′- and 2,4′-diphenylmethane diisocyanate, or a mixture of (i) and (ii); and (iii) 2,4′ and 2,6-toluene-diisocyanate and their corresponding isomeric mixtures.

PMDI in its various forms is a preferred isocyanate for use with the present disclosure. When used, it preferably has an equivalent weight between 125 and 300, more preferably from 130 to 175. The isocyanate can have a functionality from 2.5 to 3. As used herein, the functionality of the isocyanate is the number of isocyanate groups [—N═C═O] present per molecule of isocyanate. The viscosity of the isocyanate component is preferably from 25 to 5,000 centipoise (cP) (0.025 to about 5 Pa*s), but values from 100 to 1,000 cP at 25° C. (0.1 to 1 Pa*s) are possible. Similar viscosities are preferred where alternative isocyanate components are selected. Still, preferably the isocyanate component of the formulations of the present disclosure is selected from the group consisting of MDI, PMDI, an MDI prepolymer, a PMDI prepolymer, a modified MDI or a combination thereof.

Combinations of isocyanates and crude polyisocyanates polyisocyanates as well as MDI and TDI prepolymers, blends thereof with polymeric and monomeric MDI may also be used in the practice of this disclosure. The total amount of isocyanate used to prepare the foam in the present disclosure should be sufficient to provide an isocyanate reaction index of from 70 to 150 (or less). Preferably the index is from 100 to 140. More preferably the index is from 110 to 130. An isocyanate reaction index of 100 corresponds to one isocyanate group per isocyanate reactive hydrogen atom present, such as from water and the polyol composition.

### Blowing Agent

Also included in the composition for forming the polyurethane foam is a blowing agent. The blowing agent may be selected based in part upon the desired density of the final polyurethane foam. The blowing agent used in the composition of the present disclosure includes at least one physical blowing agent which is selected from a hydrocarbon, a hydrofluorocarbon, a hydrochlorofluorocarbon, a fluorocarbon, a dialkyl ether, a fluorine-substituted dialkyl ether or a combination thereof. For example, the blowing agent can be selected from the group consisting of a hydrocarbon, a hydrofluoro-olefin (HFO), a hydrochlorofluoro-olefin (HCFO), a hydrofluorocarbon or a combination thereof.

So, hydrocarbon or hydrofluorocarbon blowing agents may be used, and in some instances may serve to reduce, or further reduce, viscosity, and thereby to enhance sprayability. Among these are, for example, propane, isopentane, butane such as n-butane and isobutane, isobutene, 2,3-dimethylbutane, n- and i-pentane isomers, hexane isomers, heptane isomers, dimethyl ether, cycloalkanes including cyclopentane, cyclohexane, cycloheptane, and combinations thereof.

Examples of fluorine-containing hydrohalocarbon blowing agents can include 1,1-dichloro-1-fluoroethane (HCFC-141b), chlorodifluoromethane (HCFC-22), 1-chloro-1,1-difluoroethane (HCFC-142b), 1,1,1,2-tetrafluoroethane (HFC-134a), 1,1,1,3,3-pentafluorobutane (HFC-365mfc), 1,1-difluoroethane (HFC-152a), 1,1,1,2,3,3,3-heptafluoropropane (HFC-227ea), 1,1,1,3,3-pentafluoropropane (HFC-245fa), hydrochlorofluoroolefin (HCFO), hydrofluoroolefin (HFO), and combinations of such blowing agent. Suitable commercial products are sold under the trade designator of Formacel® 110 (DuPont™) and Solstice™ (Honeywell International Inc.). Examples of HFO and HFCO blowing agents include pentafluoropropene (HFO-1225), tetrafluoropropene (HFO-1234) and azeotrope-like compositions comprising pentafluoropropene (HFO-1225), a fluid selected from the group consisting of 3,3,3-trifluoropropene (“HFO-1243zf”), 1,1-difluoroethane (“HFC-152a”), trans-1,3,3,3-tetrafluoropropene (“HFO-1234ze”), HFO-1225yez (Z)-1,1,1,2,3-pentafluoropropene, HFO-1225ye (1,2,3,3,3-pentafluoropropene), HFO-1225zc (1,1,3,3,3-pentafluoropropene), 1,3,3,3-tetrafluoropropene (HFO-1234ze), 1,1,1,2-tetrafluoropropene (HFO-1234yf), 1,3,3,3-tetrafluoropropene (HFO-1234ez), 1,3,3,3-tetrafluoropropene (HFO-1234ze), 1,1,1,4,4,4-hexafluorobut-2-ene (HFO-1336mzz), 1-chloro-3,3,3-trifluoropropene (HCFO-1233zd), dichlorotrifluoropropene (HCFO-1223), 2-chloro-3,3,3-trifluoropropene (HCFO-1233xf) 1,1,1,2-tetrafluoropropene and the Z-isomer of 1,1,1,2,3-pentafluoropropene and combinations of two or more thereof.

An optional chemical blowing agent that may be selected is formic acid or another carboxylic acid. The formic acid may be used in an amount of from about 0.5 to about 8 parts per 100 parts by weight of the polyol composition. In certain non-limiting embodiments, the formic acid is present in an amount from about 0.5 parts and more preferably from about 1 part, up to about 6 parts and more preferably to about 3.5 parts by weight. While formic acid is the carboxylic acid of preference, it is also contemplated that minor amounts of other aliphatic mono- and polycarboxylic acids may be employed, such as those disclosed in U.S. Pat. No. 5,143,945, which is incorporated herein by reference in its entirety, and including isobutyric acid, ethylbutyric acid, ethylhexanoic acid, and combinations thereof.

The blowing agent, whether included in the formulated polyol or introduced separately during the foam preparation, is desirably present in an amount from 2 to 15 parts, based on 100 parts of the formulated polyol, and more desirably in an amount from 4 to 10 parts on the same basis.

### Polyurethane Foam Preparation

Polyurethane foam can be produced using the composition of the present disclosure using a variety of methods as discussed herein. The polyurethane foam can be, in certain non-limiting embodiments, a rigid closed-cell polymer. Such a polyurethane foam is prepared by intimately mixing the composition for forming the polyurethane foam, i.e., the formulated polyol having the polyol mixture functionality of 3.8 to 5.5, the isocyanate and the blowing agent, injecting the composition for forming the polyurethane foam under foam-forming conditions into a mold at a reduced pressure of at least 5000 pascal (Pa) below standard pressure of 100 kilopascal (kPa), curing the composition for forming the polyurethane foam in the mold, and demolding the polyurethane foam from the mold. The mixing of the composition for forming the polyurethane foam can be done at room temperature (23° C.) or at a slightly elevated temperature, where the formulated polyol and blowing agent component are mix just prior to contact with the isocyanate component. Additional streams may be included, as desired, for the introduction of various catalysts and other additives with the composition of the present disclosure. Mixing of the components of the composition for forming the polyurethane foam may be carried out either in a spray apparatus, a mixhead with or without a static mixer for combining the polyol component and blowing agent, or a vessel, and then spraying or otherwise depositing the reacting mixture onto a substrate or a mold.

The substrate may be, for example, a rigid or flexible facing sheet made of foil or another material, including another layer of similar or dissimilar polyurethane or polyisocyanurate which is being conveyed, continuously or discontinuously, along a production line, or directly onto a conveyor belt. In alternative embodiments the composition for forming the polyurethane foam may be poured into an open mold or distributed via laydown equipment into an open mold or simply deposited at or into a location for which it is destined, i.e., a pour-in-place application, such as between the interior and exterior walls of the mold. In the case of deposition on a facing sheet, a second sheet may be applied on top of the deposited mixture. In other embodiments, the mixture may be injected into a closed mold, with or without vacuum assistance for cavity-filling. If a mold is employed, it can be a heated mold.

In general, such applications may be accomplished using the known one-shot, prepolymer or semi-prepolymer techniques used together with conventional mixing methods. The mixture, on reacting, takes the shape of the mold or adheres to the substrate to produce a polyurethane foam of a more-or-less predefined structure, which is then allowed to cure in place or in the mold, either partially or fully. Suitable conditions for promoting the curing of the composition of the present disclosure include a temperature of typically from 20° C. to 150° C., preferably from 35° C. to 75° C., and more preferably from 45° C. to 55° C. Optimum cure conditions will depend upon the particular components, including catalysts and quantities used in preparing the polymer and also the size and shape of the article manufactured.

The result may be a rigid foam in the form of slabstock, a molding, a filled cavity, including but not limited to a pipe or insulated wall or hull structure, a sprayed foam, a frothed foam, or a continuously- or discontinuously-manufactured laminate product, including but not limited to a laminate or laminated product formed with other materials, such as hardboard, plasterboard, plastics, paper, metal, or a combination thereof. Advantageously, the polyurethane foam prepared in the present disclosure may show improved processability when compared with foams from formulations and preparation methods that are similar except that the formulations do not comprise the specific formulated polyol used in the present disclosure. As used herein, the term “improved processability” refers to the capability of the foam to exhibit reduced defects, which may include but are not limited to shrinkage and deformation. This improvement may be particularly advantageous when the disclosure is used in the manufacture of sandwich panels. It is preferable that such reduced levels of shrinkage and deformation be less than about 0.5 percent as linear deformation, as tested according to European Standard EN 1603 at 80° C., with specimen dimensions recorded after 20 hours. Sandwich panels may be defined, in some embodiments, as comprising at least one relatively planar layer (i.e., a layer having two relatively large dimensions and one relatively small dimension) of the rigid foam, faced on each of its larger dimensioned sides with at least one layer, per such side, of flexible or rigid material, such as a foil or a thicker layer of a metal or other structure-providing material. Such a layer may, in certain embodiments, serve as the substrate during formation of the foam.

In addition, the polyurethane foams of the disclosure may exhibit improved curing properties, including improved green compressive strength and reduced post expansion at selected foam demolding time. These features may be particularly advantageous when the disclosure is employed to produce insulated sandwich panels.

The composition of the present disclosure can also include other optional additives. Such additives include, but are not limited to, fire retardants such as phosphorous fire retardants, catalysts and surfactants. Examples of such phosphorous fire retardants include, but are not limited to, phosphates and halogen-phosphates such as triethyl phosphate (TEP) and tris(chloropropyl) phosphate (TCPP), among others.

The description hereinabove is intended to be general and is not intended to be inclusive of all possible embodiments of the disclosure. Similarly, the examples herein below are provided to be illustrative only and are not intended to define or limit the disclosure in any way. Those skilled in the art will be fully aware that other embodiments, within the scope of the claims, will be apparent, from consideration of the specification and/or practice of the disclosure as disclosed herein. Such other embodiments may include selections of specific components and proportions thereof; mixing and reaction conditions, vessels, deployment apparatuses, and protocols; performance and selectivity; identification of products and by-products; subsequent processing and use thereof; and the like; and those skilled in the art will recognize that such may be varied within the scope of the claims appended hereto.

### EXAMPLES

### Materials

Materials employed in the examples and/or comparative examples include the following.

VORANOL™ RN-490 (The Dow Chemical Company), a polyether polyol (sucrose-glycerine initiated, having a hydroxyl number of 490 mg KOH/g and a functionality of 4.3).

VORANOL™ RN-482 (The Dow Chemical Company), a polyether polyol (sorbitol initiated, having a hydroxyl number of 482 mg KOH/g and a functionality of 6).

VORANOL™ CP-1055 (The Dow Chemical Company), a polyether polyol (glycerin initiated, having a hydroxyl number of 165 mg KOH/g and a functionality of 3).

VORANOL™ 1010L (The Dow Chemical Company), a polyether polyol (glycerin initiated, having a hydroxyl number of 112.5 mg KOH/g and a functionality of 2).

IP-9001 (The Dow Chemical Company), a polyester polyol (an aromatic polyester polyol, having a hydroxyl number of 220 mg KOH/g and a functionality of 2).

IP-9004 (The Dow Chemical Company), a polyester polyol (an aromatic polyester polyol, having a hydroxyl number of 270 mg KOH/g and a functionality of 2.7).

Triethylphosphate (TEP, a fire retardant) available from Quimidroga S.A.

Trichloro isopropyl phosphate (TCPP, a fire retardant) available from Quimidroga S.A.

Pentamethyldiethylene triamine (PMDETA (Polycat 5), catalyst, Air Products and Chemicals, Inc.).

Dimethylcyclohexyl amine (DMCHA, catalyst, Air Products and Chemicals, Inc.).

TEGOSTAB® B 8474 (Polysiloxane, surfactant, Evonik Industries).

c-Pentane (cyclopentane, blowing agent, Sigma-Aldrich).

VORANATE™ M-220 (The Dow Chemical Company), a polymeric methylene-diphenyl-diisocyanate, a functionality of 2.7).

Abbreviations: PO (propylene oxide), DCP (insulated panels produced using a discontinuous process) and PU (polyurethane).

### Sample Preparation and Test Procedures

Prepare the Examples and Comparative Examples (provided below and in Table 1, below) by feeding the composition (e.g., formulated polyol and isocyanate, thermostated at 20-22° C.) through a Cannon high pressure machine and inject the composition into a Brett mold (0.1 meter (m) x 0.35 m x 2 m) equipped with vacuum pump system and a thermal heating system in order to control mold temperature. Set the pressure inside the Brett mold cavity before injecting the composition.

Measure free rise density (FRD) of the Example and Comparative Example foams poured into a 20×20×20 cm wooden box, in the proper amount to at least reach, at the end of blowing phase, the mold height.

The minimum filling density (MFD) is the minimum weight of material that is needed to fill the Brett mold. This value divided by mold volume equals the density needed to fill the mold.

The flow index is taken as the ratio between MFD and FRD.

Calculate demolding time as the time from the start of the foam injection to the opening of the mold in order to withdraw manufactured item.

Calculate the average density deviation (ADD) from seventeen (17) foam specimens formed in the Brett mold. Calculate the ADD as follows:

$$ADD = {\sum }_{I = 1} \frac{17 \vert \overline{d} - di \vert}{17}$$

where: 17 is the number of samples

d̅ is the average density

dᵢ is the density of the i^{th} sample

Measure compressive strength according to EN826.

Measure thermal insulation (lambda value) according to EN12667 by means of guarded hot plate apparatus.

Measure gel time by means of an iron stick, where gel time is taken as the time at which the foam undergoing reaction sticks to the iron stick to form strings when it is removed from the foam mass.

Measure post expansion percentage by physical measurement of foam removed out of Brett mold at defined time: [(maximum foam thickness−mold thickness)/mold thickness]×100.

For the polyurethane foam of the Examples and Comparative Examples determine a surface curing percentage for a given cure time of 10 minutes and a give cure temperature in the Brett mold by measuring the area of the Brett mold without any attached layer of polyurethane foam (attached layer having a thickness of at least about 0.1 mm). The percentage of this area versus the total mold surface area gives the percentage of surface curing. The areas are measured using digital images of the mold surfaces and digital image processing software, such as ImageJ, among others.

### Examples 1 through 4 and Comparative Examples A and B

Prepare each of the Examples 1 through 4 and Comparative Examples A and B according to the components provided in Table 1, where the amounts provided for each component are by weight percent based on the total weight of the composition. Each of the Examples 1 through 4 and Comparative Examples A and B include a sucrose-glycerine initiated polyether polyol (VORANOL™ RN-490, having a hydroxyl number of 490 mg KOH/g and a functionality of 4.3) and a sorbitol-initiated polyether polyol (VORANOL™ RN-482, having a hydroxyl number of 482 mg KOH/g and a functionality of 6). Comparative Example A includes a glycerin initiated polyether polyol (VORANOL™ CP-1055, having a hydroxyl number of 165 mg KOH/g and a functionality of 3). Examples 1 through 4 have a polyol mixture functionality of 4.17 to 4.33. Comparative Examples A and B have a polyol mixture functionality of 3.5 to 3.84.

The polyol mixture is admixed with water, fire retardants, catalyst and a surfactant as provided in Table 1. The admixture is then reacted with an isocyanate (VORANATE™ M 220) and c-pentane to form a free rise foam. The compositions of each formulation are shown in Table 1.

TABLE 1
Examples and Comparative Cases

| | function- | | | | | | |
|---|---|---|---|---|---|---|---|
| | ality | Ex. 1 | Ex. 2 | Ex. 3 | Ex. 4 | Comp. A | Comp. B |
| Voranol RN-490 | 4.3 | 14 | 14 | 4 | 4 | 20 | 4 |
| Voranol RN-482 | 6 | 57.64 | 57.64 | 57.64 | 57.64 | 27.64 | 47.64 |
| Voranol CP-1055 | 3 | 0 | 0 | | | 20 | |
| IP-9004 | 2.7 | 10 | | 20 | 20 | 14 | 30 |
| IP-9001 | 2 | | 10 | | | | |
| Triethyl | | 4.00 | 4.00 | 4.00 | 4.00 | 4.00 | 4.00 |
| phosphate (TEP) | | | | | | | |
| Trichloroisopropyl | | 10.00 | 10.00 | 10.00 | 10.00 | 10.00 | 10.00 |
| phosphate (TCPP) | | | | | | | |
| Polycat 5 | | 0.08 | 0.08 | 0.08 | 0.08 | 0.08 | 0.08 |
| Dimethylcyclohexyl | | 0.73 | 0.73 | 0.73 | 0.73 | 0.73 | 0.73 |
| amine (DMCHA) | | | | | | | |
| Tegostab B 8474 | | 2.00 | 2.00 | 2.00 | 2.00 | 2.00 | 2.00 |
| water | | 1.55 | 1.55 | 1.55 | 1.55 | 1.55 | 1.55 |
| Polyol mixture | | 4.33 | 4.26 | 4.17 | 4.17 | 3.5 | 3.84 |
| functionality vs. | | | | | | | |
| formulated polyol | | | | | | | |
| total weight | | | | | | | |
| Total | | 100.00 | 100.00 | 100.00 | 100.00 | 100.00 | 100.00 |
| c-Pentane | | 13 | 13 | 13 | 14 | 12 | 12 |
| Voranate M 220 | | 136 | 135 | 130 | 152 | 116 | 124 |
| isocyanate | | | | | | | |
| index | | 1.2 | 1.2 | 1.2 | 1.4 | 1.2 | 1.2 |
| free rise density (g/l) | | 26.8 | 26.7 | 25.6 | 26.5 | 26.2 | 26.8 |
| gel time (sec) | | 93 | 95 | 95 | 100 | 106 | 100 |
| Brett mold | | 1 atm | 1 atm | 1 atm | 1 atm | 1 atm | 1 atm |
| (0.1 × 0.35 × 2)m; P 1 | | | | | | | |
| atm, 40° C. | | | | | | | |
| Minimum Filling | | 37 | 36 | 34.93 | 36 | 33.32 | 33.9 |
| Density (g/l) | | | | | | | |
| flow index | | 1.381 | 1.348 | 1.364 | 1.358 | 1.272 | 1.265 |
| applied density | | 40.6 | | | | | |
| ADD (density | | 0.492 | | | | | |
| distribution) | | | | | | | |
| compressive strength | | 231 | | | | | |
| (kPa) | | | | | | | |
| lambda (mW · m° K), | | 21.03 | | | | | |
| 10° C. | | | | | | | |
| Post expansion (max | | 103.8 | | | | | |
| thickness), | | | | | | | |
| at demold time | | | | | | | |
| 10 min | | | | | | | |
| Brett mold | | 900 mbar | 900 mbar | 900 mbar | 900 mbar | 900 mbar | 900 mbar |
| (0.1 × 0.35 × 2)m; P | | | | | | | |
| 900 mbar, 40° C. | | | | | | | |
| Minimum Filling | | 29.4 | 31.2 | 30.9 | 31.13 | 28.65 | 30.5 |
| Density (g/l) | | | | | | | |
| flow index | | 1.097 | 1.169 | 1.207 | 1.175 | 1.094 | 1.138 |
| applied density | | 33.9 | 33.9 | 33.9 | 33.9 | 33.9 | 33.9 |
| surface curing (%, | | 100 | 100 | 100 | 100 | <60 | <60 |
| qualitative | | | | | | | |
| estimation) | | | | | | | |
| ADD (density | | 0.286 | 0.249 | 0.321 | 0.232 | 0.203 | 0.35 |
| distribution) | | | | | | | |
| compressive strength | | 97 | 103 | 114 | 102 | 106 | 100 |
| (kPa) | | | | | | | |
| lambda (mW · m° K), | | 20.1 | 20.65 | 20.63 | 20.57 | 21.14 | 20.42 |
| 10° C. | | | | | | | |
| Post expansion (max | | 102.97 | 102.44 | 102.93 | 102.55 | 104.0 | 103.8 |
| thickness), | | | | | | | |
| at demold time | | | | | | | |
| 10 min | | | | | | | |
| applied density | | | | | 35.7 | | |
| Post expansion (max | | | | | 103.32 | | |
| thickness), | | | | | | | |
| at demold time | | | | | | | |
| 10 min | | | | | | | |
| compressive strength | | | | | 131 | | |
| (kPa) | | | | | | | |

1. A composition for forming a polyurethane foam under a reduced pressure, comprising:
a formulated polyol having:
60 weight percent (wt. %) to 80 wt. % of a sucrose-initiated or a sorbitol-initiated polyether polyol having a polyol functionality of greater than or equal to 4; and
10 wt. % of an aromatic polyester polyol having a functionality of 2,
where the wt. % are based on a total weight of the formulated polyol, and where the formulated polyol has a polyol mixture functionality of at least 4.26;
an isocyanate; and
a blowing agent.

2.-3. (canceled)

4. The composition of claim 2, where the polyether polyol has a hydroxyl number of 300 mg KOH/g to 600 mg KOH/g.

5. (canceled)

6. The composition of claim 1, where the aromatic polyester polyol is a diethylene glycol-phthalic anhydride based polyester polyol.

7. (canceled)

8. The composition of claim 5, where the aromatic polyester polyol has a hydroxyl number of 150 mg KOH/g to 350 mg KOH/g.

9. The composition of claim 1, where the isocyanate has a functionality from 2.5 to 3.

10. The composition of claim 9, where the isocyanate is a polymeric methylene diphenyl diisocyanate.

11. The composition of claim 1, where the blowing agent is selected from the group consisting of a hydrocarbon, a hydrofluoro-olefin (HFO), a hydrochlorofluoro-olefin (HCFO), a hydrofluorocarbon or a combination thereof.

12. A polyurethane foam produced using the composition for forming a polyurethane foam of claim 1.

13. A method of forming a polyurethane foam, comprising:
injecting a composition for forming a polyurethane foam of claim 1 under foam-forming conditions into a mold at a reduced pressure of at least 5000 pascal below standard pressure of 100 kilopascal;
curing the composition for forming the polyurethane foam in the mold; and
demolding the polyurethane foam from the mold.
